(19) United States
(12) Patent Application Publication
(10) Pub. No.: US 2025/0013827 A1
(43) Pub. Date: Jan. 9, 2025

(54) GENERATING EXPLANATIONS OF CONTENT RECOMMENDATIONS USING LANGUAGE MODEL NEURAL NETWORKS

(71) Applicant: Google LLC, Mountain View, CA (US)

(72) Inventors: Brian Chu, New York, NY (US); Manoj Kumar Tiwari, Santa Clara, CA (US)

(21) Appl. No.: 18/766,442

(22) Filed: Jul. 8, 2024

Related U.S. Application Data
(60) Provisional application No. 63/512,269, filed on Jul. 6, 2023.

(51) Int. Cl. G06F 40/284

(52) U.S. Cl. CPC G06F 40/284

(57) ABSTRACT

Methods, systems, and apparatus, including computer programs encoded on computer storage media, for generating an explanation of a content item recommendation. For example, a system can use a language model neural network to generate a natural language explanation of why a particular content item was recommended given the context of the recommendation.

### CROSS-REFERENCE TO RELATED APPLICATION

This application claims priority to U.S. Provisional Application No. 63/512,269, filed on Jul. 6, 2023. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates text that provides an explanation of why a given content item was recommended to a given user by a content recommendation system.

Particular embodiments of the subject matter described in this specification can be implemented so as to realize one or more of the following advantages.

The techniques described in this specification allow a system to use a language model neural network to generate “post hoc” explanations for “black box” content recommendation systems. This means that explanations can be generated after the recommendation has been selected and the system that generates the explanations can be independent from the implementation of the recommendation system, i.e., does not need to have any access to model components or training details of the recommendation system. Thus, the system leverages a language model neural network to frame the decision that the recommender had already made in a more understandable manner to a user by taking into account the existing context as well as the specific recommendation.

Contrary to other approaches, the described system can provide explanations in natural language, generate a wide variety of explanations, personalize explanations to the user, and highlight relevant aspects of the recommended content item. Moreover, because the system does not require any access to any internal components of the recommender system, the described techniques can be deployed for a variety of applications and do not need to be re-trained or updated if the underlying content recommendation system is modified.

By making use of the described techniques, a system can increase transparency (and user trust) in the recommendations made by the recommendation system and provide context on how, if at all, user data is being used to generate content recommendations.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example neural network system.

FIG. 1B shows an example of the operation of the neural network system.

FIG. 2 is a flow diagram of an example process for generating an explanation of a content item recommendation.

FIG. 3 is a flow diagram of an example process for providing an explanation of a content item recommendation to a user.

Like reference numbers and designations in the various drawings indicate like elements.

### DETAILED DESCRIPTION

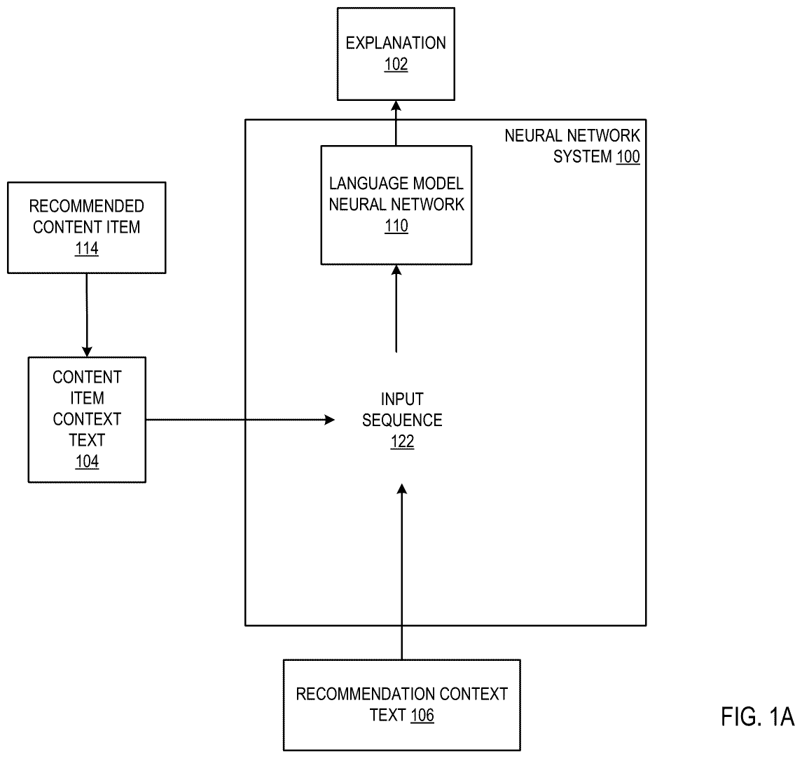

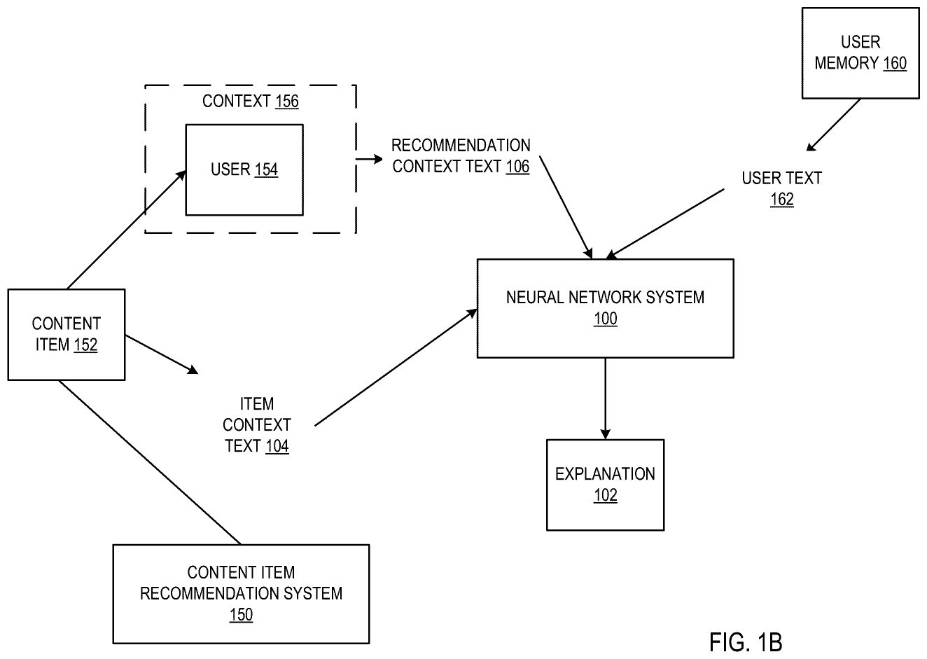

FIG. 1A shows an example neural network system 100. The neural network system 100 is an example of a system implemented as computer programs on one or more computers in one or more locations, in which the systems, components, and techniques described below can be implemented.

The system 100 is a system that generates explanation text 102 that represents a natural language explanation of why a content recommendation system recommended a particular content item 114 to a user in a given content recommendation context.

The “content recommendation context” refers to the context in which the context recommendation was made and in which the context recommendation system operates.

For example, the content recommendation system can generate content recommendations during a conversation between the user and one or more other entities, e.g., another user or a chatbot or both.

As another example, the content recommendation system can generate content recommendations in response to search queries submitted by the user to a search engine, e.g., an Internet search engine that searches web pages on the Internet, an image search engine that searches a repository of images, a video search engine that searches a repository of videos, an app store search engine that searches a repository of software applications that are available for download, an electronic book store search engine that searches a repository of electronic books, and so on.

As another example, the content recommendation system can generate content recommendations that are presented while a user is viewing or otherwise interacting with a current content item, e.g., of content items that may be of interest to the user given that the user is viewing the current content item. For example, the user may be viewing an app in an app store (or data identifying the app) and the recommended content items can be other apps available in the app store. As another example, the user may be viewing a video available on a video sharing platform (or data identifying the video) and the recommended content items can be other videos available in the app store. As yet another example, the user may be viewing an electronic book (or data identifying an electronic book) and the recommended content items can be other available electronic books.

The particular content item can be any appropriate type of content item, e.g., a video, an electronic book, a software application, a news article, a web page, a music content item, e.g., a song, a web page or other resource describing a product, and so on.

To generate the explanation text 102, the system 100 obtains item context text 104 that characterizes the particular content item 114 that was recommended to the user by the content recommendation system in the content recommendation context.

For example, the system 100 can receive item metadata of the particular content item and generate natural language text that describes the metadata, e.g., by performing summarization to generate a natural language summary of the metadata.

The system 100 also obtains recommendation context text 106 characterizing the content recommendation context.

In other words, the system 100 obtains natural language text characterizing the content recommendation context and the content item 114 that as recommended to the user.

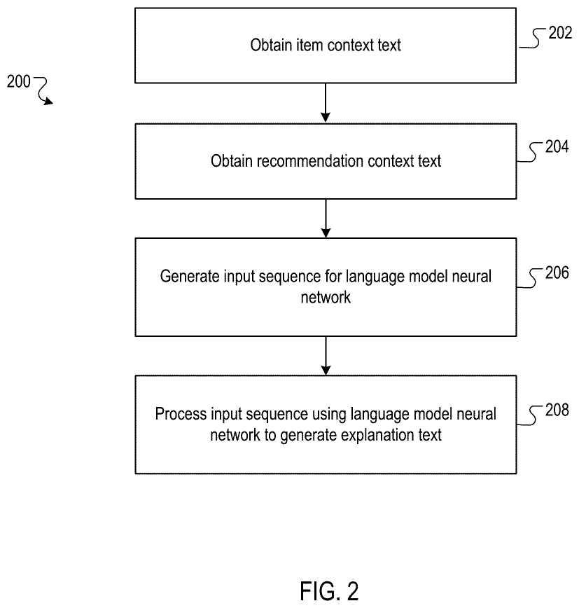

Obtaining these inputs will be described in more detail below with reference to FIG. 2.

The system 100 generates, from the recommendation context 106 and the item context text 104, an input sequence 122 to a language model neural network 110 and processes the input sequence 122 using the language model neural network 110 to generate, as output, the explanation text 102 that represents an explanation of why the particular content item was recommended to the user in the content recommendation context.

Generally, the language model neural network 110 is an auto-regressive neural network that generates output sequences of tokens from a vocabulary, e.g., conditioned on a context sequence.

The neural network 110 is referred to as an auto-regressive neural network because the neural network 110 auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence. For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input sequence and the current output sequence can be separated by one or more predetermined tokens within the current input sequence.

More specifically, to generate a particular token at a particular position within an output sequence, the neural network 110 can process the current input sequence to generate a score distribution, e.g., a probability distribution, that assigns a respective score, e.g., a respective probability, to each token in the vocabulary of tokens. The neural network 110 can then select, as the particular token, a token from the vocabulary using the score distribution. For example, the neural network 110 can greedily select the highest-scoring token or can sample, e.g., using nucleus sampling or another sampling technique, a token from the distribution.

As a particular example, the language model neural network 110 can be an auto-regressive Transformer-based neural network that includes (i) a plurality of attention blocks that each apply a self-attention operation and (ii) an output subnetwork that processes an output of the last attention block to generate the score distribution.

The neural network 110 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al., Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B. Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al., Language models are few-shot learners. arXiv preprint arXiv: 2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates at least the hidden state for the last token in the given input sequence at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

An “embedding,” as used in this specification is a vector of numeric values, e.g., floating point or other type of numeric values, that has a predetermined dimensionality, e.g., has a predetermined number of values.

In this example, the output subnetwork processes the output hidden state generated by the last attention block in the sequence for the last input token in the input sequence to generate the score distribution.

In other words, the language model neural network 110 is configured to map each token in the input sequence to a respective embedding and then process the embeddings through the attention blocks within the language model neural network 110 as part of generating the explanation text 102.

Generally, the language model neural network 110 has been pre-trained. For example, the system 100 or another training system can have pre-trained the language model neural network 110 on a language modeling task, e.g., a task that requires predicting, given a current sequence of text tokens, the next token that follows the current sequence in the training data. As a particular example, the language model neural network 110 can be pre-trained on a next token prediction objective, i.e., a maximum-likelihood objective on a large dataset of text, e.g., text that is publicly available from the Internet or another text corpus.

In some cases, the system 100 adapts the language model neural network 110 for the task of generating explanations, e.g., through fine-tuning or prompt tuning.

In some cases, in addition to or instead of adapting the neural network 110, the system 100 also includes, in the input sequence, a few-shot prompt sequence that includes one or more example input-output pairs that each include (i) respective example recommendation context text and item context text and (ii) respective example explanation text.

By virtue of adapting the language model neural network 110, including the few-shot prompt, or both, the system 100 can cause the neural network 110 to generate explanation text 110 at various levels of granularity and of various lengths, e.g., shorter explanations that give succinct, high-level reasons for why the particular content item was deemed relevant or longer, detailed explanations that explain the connection between the presentation setting and the particular context item. That is, the system 100 can use the same neural network 110 to generate different explanation text 102 with different granularities and lengths for different users.

After the explanation text 102 has been generated, the system 100 or another system can use the explanation text 102 for any of a variety of purposes. Some example purposes are described below.

For example, the system 100 can present a short explanation of the recommended item to the user, e.g., as a “fun fact” to get a brief idea about the item before deciding if the user wants to interact with the item.

As another example, the system 100 can present a longer description to the user (or someone attempting to debug model/recommendation system behavior) to interpret the connection between user data/context and the recommended item.

As another example, the system 100 can present the shorter explanation to the user to further explore recommendations, resulting in increased controllability in user journeys.

FIG. 1B shows an example of the operation of the system 100.

In the example of FIG. 1B, a content item recommendation system 150 has recommended a content item 152 to a user 154.

For example, the content recommendation system 150 can have made the content recommendation during a conversation between the user 154 and one or more other entities, e.g., other users, chatbots, or a combination of the two. That is, a context 156 for the recommendation is a conversation between the user 154 and the one or more other entities.

As shown in FIG. 1B, after the system 150 has made the recommendation of the content item 152 to the user 154, the system 100 obtains the item context text 104 and the recommendation context text 106.

For example, the system 100 can receive item metadata of the content item 152 and generate natural language text that describes the metadata, e.g., by performing summarization to generate a natural language summary of the metadata, for use as the item context text 104.

In the example where the context 156 is a conversation, the system 100 can obtain data describing the conversation and can, e.g., perform conversation summarization, to generate a natural language summary of the conversation for use as the recommendation context text 106. In the example of FIG. 1B, the system 100 also obtains user text 162 from a user memory 160 that stores data relevant to the user 154, e.g., long-term topics of interest of the user 154.

The system 100 then generates the explanation text 102 from the item context text 104, the recommendation context text 106 and, optionally, the user text 162.

FIG. 2 is a flow diagram of an example process 200 for generating an explanation of a content item recommendation. For convenience, the process 200 will be described as being performed by a system of one or more computers located in one or more locations. For example, a neural network system, e.g., the neural network system 100 of FIG. 1A, appropriately programmed, can perform the process 200.

The system obtains item context text characterizing a particular content item that was recommended to a user by a content recommendation system in a content recommendation context (step 202).

In some cases, the system receives the context text from another system. For example, the system can query a search engine or other external system for a natural language description of the content item and use the received description as the context text.

In some other cases, the system generates the item context text based on information about the content item.

For example, the system can obtain metadata for the particular content item and then generate a natural language text description of the metadata. For example, the system can process the metadata and an appropriate prompt using the language model neural network or another language model neural network to generate a natural language text description of the metadata. As a particular example, the natural language text description can be a natural language summary of the metadata. That is, the appropriate prompt can instruct the language model neural network to generate a summary of the metadata.

The metadata obtained by the system can depend on the type of the content item.

For example, when the particular content item is a video, the metadata can include any one or more of: the video title; a video description, e.g., a natural language description of the video provided by the creator of the video or automatically generated by a video repository; text captions for audio from the video; salient terms for the video; relevant entities for the video; or topic tags that identify relevant topics for the video.

As another example, when the particular content item is a news article, the metadata can include any one or more of: a headline of the article; text of the article; a publisher of the article; or an author of the article.

As another example, when the particular content item is a web page that describes a product, the metadata can include any one or more of: the product name; a product description; a price of the product; or specifications of the product.

As another example, when the particular content item is an electronic book, the metadata can include any one or more of: a title of the book; text from the book; a summary of the book; relevant topics for the book; a publisher of the book; or an author of the book.

As another example, when the particular content item is a music content item, e.g., one or more songs available for download or streaming by the user, the metadata can include any one or more of: a title of the music content item; lyrics from the music content item; a genre of the music content item; a description of the music content item; or an artist relevant to the music content item.

As another example, when the particular content item is a software application, the metadata can include any one or more of: a type of the software application; a description of the software application; or a publisher of the software application.

The system obtains recommendation context text characterizing the content recommendation context (step 204).

In some cases, the system receives the recommendation context text from another system.

In some other cases, the system generates the recommendation context text based on information about the content recommendation context.

For example, the system can obtain text that provides context for the content recommendation context and generate a natural language text summary of the text that provides context for the content recommendation context. As one example, the system can process the text that provides context for the content recommendation context and an appropriate prompt using the language model neural network or another language model neural network to generate the natural language summary.

The text that provides the context can generally be any appropriate text that provides information about the context in which the content recommendation occurred.

Some examples of text that can be included as part of the context (alone or combined with other text) are now described.

For example, when the content recommendation context is a conversation between a user and another entity, e.g., another user or a chatbot, the text that provides context for the content recommendation context can include one or more conversational turns from the conversation.

As another example, when the content recommendation context is a response to a search query submitted by the user, the text that provides context for the content recommendation context includes text of the search query submitted by the user. In some cases, to provide additional context, the text that provides context for the content recommendation context includes one or more previous search queries submitted by the user.

As another example, the text that provides context for the content recommendation context can also include data describing one or more previous content items that have been previously recommended to the user by the content recommendation system. For example, the data describing any given previous content item can be (i) metadata describing the content item as described above or (ii) a natural language description of the metadata generated as described above.

As another example, the text that provides context for the content recommendation context can also include data characterizing user interactions with the one or more previous content items that have been previously recommended to the user by the content recommendation system. For example, for a given content item, this data can indicate whether the user interacted with, i.e., selected or otherwise accessed, the content item when the content item was recommended to the user. In some of these examples, this data can also indicate, if the user interacted with the content item, a degree of interaction of the user with the content item, e.g., how much of a video the user played back, how much of a book the user read, and so on.

The system generates, from the recommendation context text and the item context text, an input sequence to a language model neural network (step 206).

For example, the input sequence can include the recommendation context text and the item context text and a prompt sequence that provides information to the language model neural network. For example, the input sequence can include the prompt sequence followed by the recommendation context text and then the item context text or the prompt sequence followed by the item context text and the recommendation context text. Optionally, different parts of the input sequence can be separate by respective pre-determined separator text.

As one example, the prompt sequence can include a natural language instruction that instructs the language model neural network to generate an explanation given the recommendation context text and the item context text.

As another example, instead of or in addition to the natural language instruction, the prompt sequence can include one or more example input-output pairs. Each pair can, in turn, include (i) respective example recommendation context text and item context text and (ii) respective example explanation text, with the respective example explanation text being an explanation of why the content item characterized by the item context text was recommended in the context characterized by the respective example recommendation context text.

As yet another example, instead of or in addition to one or both of the natural language instruction and the example pairs, the prompt sequence can also include a “soft” prompt that includes one or more tunable tokens. A “tunable” token is a token that is not in the vocabulary of tokens and that has an embedding that has been learned through prompt tuning.

For example, after the language model neural network has been pre-trained, the system can train the language model neural network through prompt tuning, i.e., where only the embeddings for the tunable tokens are updated and the parameters of the language model neural networks are held fixed on a set of training examples. Each training example can include (i) a respective training input sequence and (ii) respective training explanation text, where each training input sequence includes the tunable tokens and at least a recommendation context text and an item context text. During the training of the language model neural network, the system can update the embeddings of the tunable tokens by backpropagating gradients of an objective function, e.g., a negative log likelihood or other next token prediction objective, that is based on the training explanation texts, while holding the parameters of the language model neural network fixed,

As yet another example, instead of or in addition to one or more of the natural language instruction, the example pairs, and the soft prompt, the prompt sequence can include a chain-of-thought prompt. A chain-of-thought prompt is one that instructs the language model neural network to generate one or more intermediate outputs prior to generating the final explanation text. For example, the chain-of-thought prompt can include multiple reasoning examples, with each example including example intermediate reasoning steps that result in an example explanation.

Optionally, the input sequence can include additional information other than the recommendation context, the item context text and the prompt sequence.

For example, the system can obtain user text that represents topics of interest to the user to whom the content recommendation was made. For example, the system can obtain the user text from a user profile of the user or topics associated with content items previously interacted with by the user.

The system can then include the user text as part of the input sequence, i.e., so that the system generates the input sequence from the recommendation context, the item context text, and the user text and optionally the prompt sequence.

The system processes the input sequence using the language model neural network to generate, as output, explanation text that represents an explanation of why the particular content item was recommended to the user in the content recommendation context (step 208).

When the prompt sequence includes a chain-of-thought prompt, the system can discard the intermediate output(s) and use only the final explanation text as the final explanation.

As described above, depending on how the language model neural network has been trained, on the contents of the prompt sequence or both, the explanation can be a long or short form explanation. For example, if a user had previously searched for animals, pets, and sledding, a video with a husky pulling a sled can have a longer explanation like “This video was shown because it shows someone riding a sled while their husky pulls it and you asked for videos about pets and sledding. The person is sledding with their pet husky.” Alternative, the explanation can be a shorter explanation like “person sledding with their husky”.

Once the system has generated the explanation, the system can provide the explanation text for presentation to a user.

For example, the system can provide the explanation text for presentation to the user to whom the content item was recommended.

As another example, the system can provide the explanation text for presentation to a different user, e.g., a system administrator or other user reviewing the recommendations made by the recommendation system, e.g., to evaluate or debug the performance of the recommendation system.

In some cases, the system can personalize the explanation based on the user to whom the explanation will be presented. For example, the system can include different prompt sequences to different users, e.g., based on preferences of the user, e.g., long vs short form explanations, or based on previous interactions of the user with the system. For example, if a user submits feedback indicating a preference for longer-form explanations, the system can include a prompt sequence that causes the language model to generate longer-form explanations.

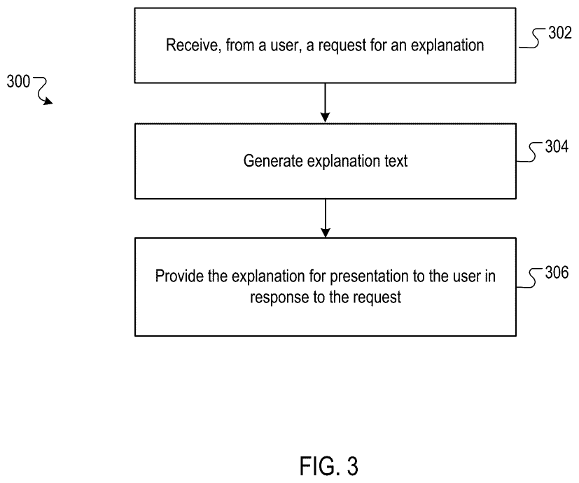

FIG. 3 is a flow diagram of an example process 300 for providing an explanation of a content item recommendation to a user. For convenience, the process 300 will be described as being performed by a system of one or more computers located in one or more locations. For example, a neural network system, e.g., the neural network system 100 of FIG. 1A, appropriately programmed, can perform the process 300.

The system receives, from a user, a request for an explanation for a particular content item recommendation (step 302). For example, the user can have been provided a recommendation of a content item in a given context and can have selected a user interface element to obtain more information about the particular content item. As another example, the user can have submitted a query, e.g., a natural language text query or voice query, to the system asking for more information about a particular content item that was recommended to the user.

The system generates explanation text that represents an explanation of why the particular content item was recommended to the user in the content recommendation context (step 304), e.g., by performing the process 200 described above. While step 304 is shown as being performed after step 302 in FIG. 2, in some cases the system can have pre-generated the explanation text. For example, the system can automatically generate the explanation text when any given content item recommendation is generated.

The system provides the explanation text for presentation to the user in response to the request (step 306).

In some cases, as described above, the explanation text can identify one or more topics that are relevant to the particular content item. In these cases, the system can provide, for presentation to the user, a respective link for each of the one or more topics that, when selected by the user, causes additional content items that are relevant to the topic to be presented to the user.

For example, selecting the link can cause a search query describing the topic to be submitted to a search engine that searches a repository of content items. The search results generated by the search engine, i.e., that each identify a respective content item from the repository, can then be provided for presentation to the user in response to the selection of the link.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising;
obtaining item context text characterizing a particular content item that was recommended to a user by a content recommendation system in a content recommendation context;
obtaining recommendation context text characterizing the content recommendation context;
generating, from the recommendation context text and the item context text, an input sequence to a language model neural network; and
processing the input sequence using the language model neural network to generate, as output, explanation text that represents an explanation of why the particular content item was recommended to the user in the content recommendation context.

2. The method of claim 1, further comprising:
providing the explanation text for presentation to the user.

3. The method of claim 2, further comprising:
receiving, from the user, a request for an explanation for the particular content item; and
wherein providing the explanation text for presentation to the user comprises providing the explanation text in response to the request.

4. The method of claim 2, wherein the explanation text identifies one or more topics that are relevant to the particular content item, and wherein providing the explanation text for presentation to the user comprises providing, for presentation to the user, a respective link for each of the one or more topics that, when selected by the user, causes additional content items that are relevant to the topic to be presented to the user.

5. The method of claim 1, wherein the input sequence comprises the recommendation context text, the item context text, and a prompt sequence.

6. The method of claim 5, wherein the prompt sequence includes one or more example input-output pairs that each include (i) respective example recommendation context text and item context text and (ii) respective example explanation text.

7. The method of claim 5, wherein:
the language model neural network is configured to map each token in the input sequence to a respective embedding,
the prompt sequence includes one or more tunable tokens, and
the respective embeddings for each of the one or more tunable tokens have been learned through prompt tuning on a set of training examples after the language model neural network has been pre-trained, and wherein each training example includes (i) a respective training input sequence and (ii) respective training explanation text.

8. The method of claim 5, wherein the prompt sequence comprises a chain-of-thought prompt.

9. The method of claim 1, further comprising:
obtaining user text that represents topics of interest to the user; and wherein generating, from the recommendation context and the item context text, an input sequence to a language model neural network comprises:
generating the input sequence from the recommendation context, the item context text, and the user text.

10. The method of claim 1, wherein obtaining item context text characterizing a particular content item that was recommended to a user in a content recommendation context comprises:
obtaining metadata for the particular content item; and
generating a natural language text description of the metadata.

11. The method of claim 10, wherein the particular content item is a video and the metadata comprises one or more of:
a video title;
a video description;
text captions for audio from the video;
salient terms for the video;
relevant entities for the video; or
topic tags that identify relevant topics for the video.

12. The method of claim 10, wherein the particular content item is a news article and the metadata comprises one or more of:
a headline of the article;
text of the article;
a publisher of the article; or
an author of the article.

13. The method of claim 10, wherein the particular content item is a web page describing a product and the metadata comprises one or more of:
a product name;
a product description;
a price of the product; or
specifications of the product.

14. The method of claim 10, wherein the particular content item is an electronic book and the metadata comprises one or more of:
a title of the book;
text from the book;
a summary of the book;
relevant topics for the book;
a publisher of the book; or
an author of the book.

15. The method of claim 10, wherein the particular content item is a music content item and the metadata comprises one or more of:
a title of the music content item;
lyrics from the music content item;
a genre of the music content item;
a description of the music content item; or
an artist relevant to the music content item.

16. The method of claim 10, wherein the particular content item is a software application and the metadata comprises one or more of:
a type of the software application;
a description of the software application; or
a publisher of the software application.

17. The method of claim 10, wherein generating a natural language text description of the metadata comprises generating a natural language summary of the metadata.

18. The method of claim 1, wherein obtaining recommendation context text characterizing the content recommendation context comprises:
obtaining text that provides context for the content recommendation context; and
generating a natural language text summary of the text that provides context for the content recommendation context.

19. The method of claim 18, wherein the content recommendation context is a conversation between the user and another entity, and wherein the text that provides context for the content recommendation context comprises one or more conversational turns from the conversation.

20. The method of claim 18, wherein the content recommendation context is a response to a search query submitted by the user, and wherein the text that provides context for the content recommendation context comprises text of the search query submitted by the user.

21. The method of claim 20, wherein the text that provides context for the content recommendation context comprises one or more previous search queries submitted by the user.

22. The method of claim 18, wherein the text that provides context for the content recommendation context comprises data describing one or more previous content items that have been previously recommended to the user by the content recommendation system.

23. The method of claim 22, wherein the text that provides context for the content recommendation context comprises data characterizing user interactions with the one or more previous content items that have been previously recommended to the user by the content recommendation system.

24. A system comprising one or more computers and one or more storage devices storing instructions that when executed by the one or more computers cause the one more computers to perform operations comprising:
obtaining item context text characterizing a particular content item that was recommended to a user by a content recommendation system in a content recommendation context;
obtaining recommendation context text characterizing the content recommendation context;
generating, from the recommendation context text and the item context text, an input sequence to a language model neural network; and
processing the input sequence using the language model neural network to generate, as output, explanation text that represents an explanation of why the particular content item was recommended to the user in the content recommendation context.

25. One or more computer storage media storing instructions that when executed by one or more computers cause the one more computers to perform operations comprising:
obtaining item context text characterizing a particular content item that was recommended to a user by a content recommendation system in a content recommendation context;
obtaining recommendation context text characterizing the content recommendation context;
generating, from the recommendation context text and the item context text, an input sequence to a language model neural network; and
processing the input sequence using the language model neural network to generate, as output, explanation text that represents an explanation of why the particular content item was recommended to the user in the content recommendation context.
